(19) United States
(12) Patent Application Publication
(10) Pub. No.: US 2008/0098641 A1
(43) Pub. Date: May 1, 2008

(54) SPINNER FOR BUZZ BAIT

(76) Inventor: Larry J. Brewer, Festus, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/554,918

(22) Filed: Oct. 31, 2006

(51) Int. Cl. A01K 85/00; A01K 85/10

(52) U.S. Cl. 43/43.13; 43/42.19; 43/42.2

(57) ABSTRACT

A spinner of a buzz bait has a multiplicity of connected blades mounted for rotation on a reach of a wire frame of the buzz bait, the blades generating a hollow, substantially spherical shape when rotating, and agitating wings projecting outwardly from the blades at an angle thereto. In the preferred embodiment, the spinner is made in one piece of a material that is manually bendable and shape retaining, so that the wings can be bent to an angle that the user prefers, to regulate the speed at which the spinner rises to the surface and rides with most of the spinner exposed, above the surface of the water.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates to a spinner for a buzz bait, in which a buzz bait lure is carried by a lower reach of a wire frame, and a spinner by an upper reach at an angle to the lower reach.

A thorough discussion of the various types of conventional spinner blades and the various shortcomings of spinner blades known theretofore and the ideal desiderata for spinner blades is found in U.S. Pat. No. 6,243,982, Halterman, Jr. However, Halterman has as a primary objective the provision of a spinner that resembles a small bait fish, the tail fins of which serve to cause the spinner to rotate. The spinner of the present invention bears no resemblance to a fish, has blades which generate substantially a hollow sphere when rotated, and wings that project, preferably outwardly, about midway of the length of the spinner. At the same time, the spinner of this invention accomplishes what Halterman sets out as the most desirable features of a spinner.

### BRIEF SUMMARY OF THE INVENTION

In accordance with this invention, generally stated, a spinner for a buzz bait is provided with a multiplicity of blades, preferably three, bent in a half circle, and joined at their outer ends, so that they generate substantially a hollow sphere when rotated, and wings or vanes, integral with the blades, bent, preferably outwardly, from the blades at an angle. Preferably, the vanes and blades are made of manually bendable but shape retaining material, such as aluminum of the type used for guttering, generally between about 0.027″ and 0.035″ thick, to enable the user to bend the vanes to regulate the speed at which the spinner rises to the surface.

### BRIEF DESCRIPTION OF THE SEVERAL VIEWS OF THE DRAWINGS

In the accompanying drawings which form part of the specification:

FIG. 1 is a top plan view of a blank from which the spinner is made;

FIG. 2 is a view in side elevation of a buzz bait with the assembled spinner attached;

FIG. 3 is a view in front elevation of the spinner of FIG. 1, somewhat enlarged; and

FIG. 4 is a view in rear elevation of the spinner of FIG. 3.

Corresponding reference numerals indicate corresponding parts throughout the several figures of the drawings.

### DESCRIPTION OF THE PREFERRED EMBODIMENT

The following detailed description illustrates the invention by way of example and not by way of limitation.

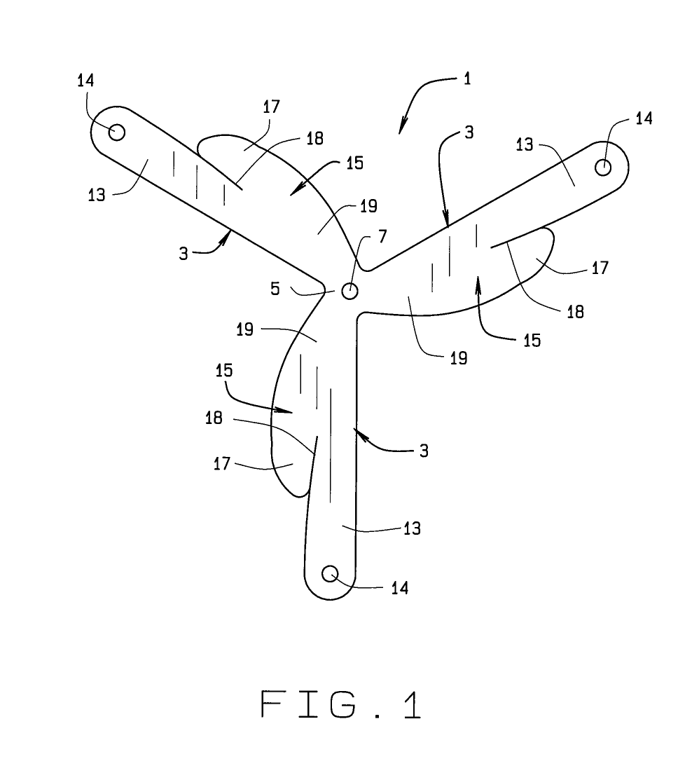

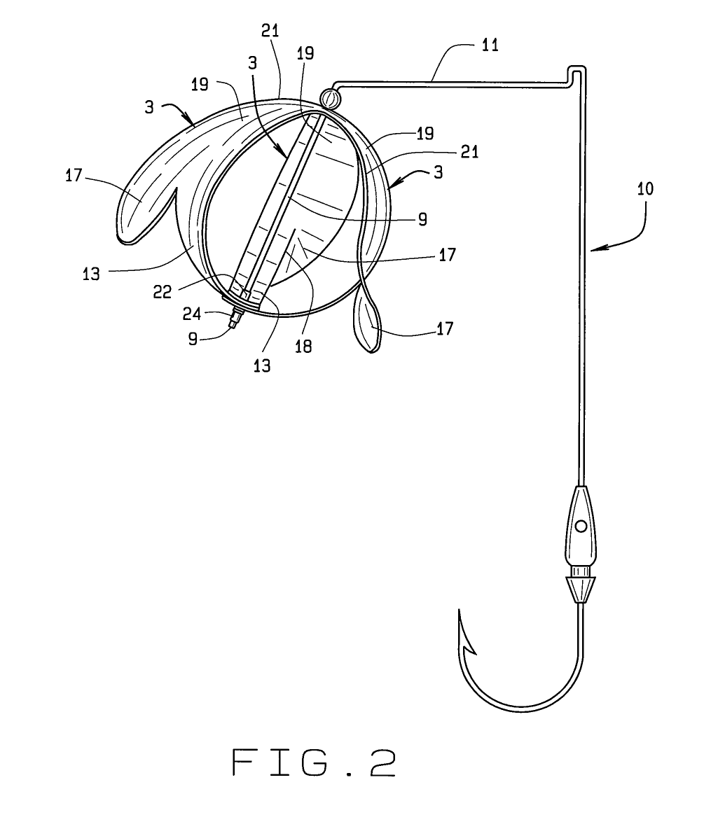

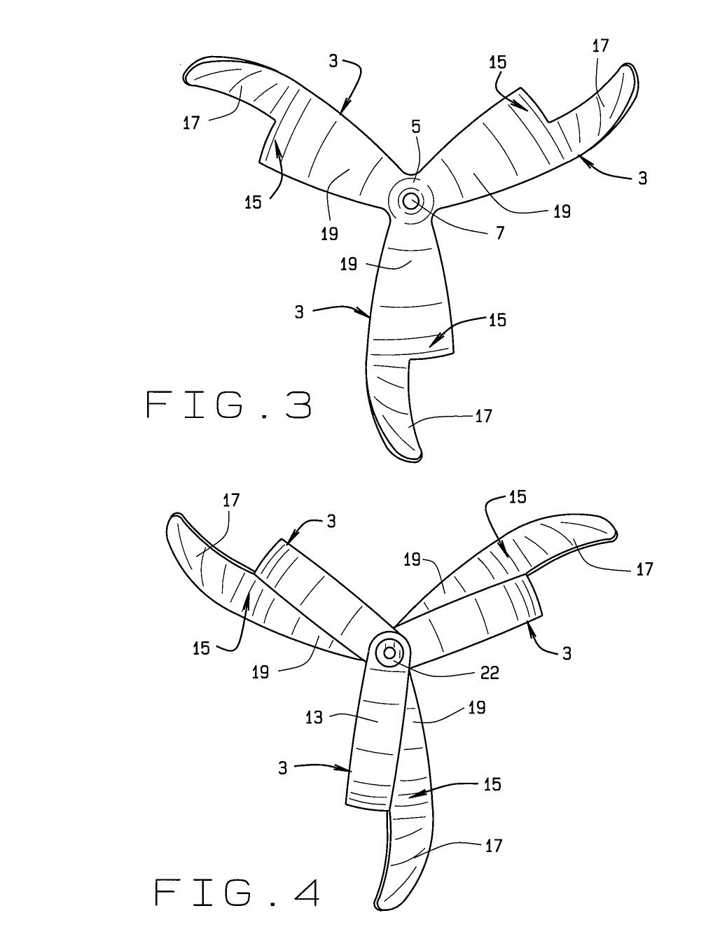

Referring now to FIG. 1 a blank 1, of a bendable but shape-retaining material such as aluminum used for guttering, has, in this embodiment, three identical blades 3. The blades 3 are joined at a hub area 5, in the center of which is a hole 7. The hole 7 is of a size loosely to admit an upper reach 9 of a buzz bait frame 10. Each of the blades 3 of the blank 1 consists of a ribbon section 13 and a wing section 15. The wing section 15 is divided into a projecting part 17 defined by a cut 18, and a root section 19.

Each of the ribbon sections 13 has near its outer end, a pop rivet receiving passage 14.

The blade section, including the ribbons 13 and the root section 19 of the wings, is bent into substantially a semi-circle, with the ends of the ribbons overlapping to align the passages 14 for the reception of a pop rivet 22, which is hollow and open at both ends, and aligned with the hole 7 to so as to receive the reach 9 of the buzz bait frame and mount the spinner for rotation. In the embodiment shown, the reach 9 extends through the pop rivet 22, through a second pop rivet 24 on the other side of the blades, and is bent down to hold the rivet 24 in place. Convex heads of the rivets 22 and 24 provide bearing surfaces that restrain the spinner but permit the spinner to rotate freely. The spinner is restrained at its other side by a bead 28, held at the arris between reach 9 and a connecting reach 11 of the frame 10.

As will be appreciated, because the ribbons overlap, if the holes 14 are in identical positions on the three blades, the figure generated by the spinner when rotated will not be a perfect sphere, and there is likely to be some small deviation from the perfect semi-circle of the blade, with the same result, but the figure generated by the revolving spinner is substantially a hollow sphere. Some correction can be made by positioning the holes 14 progressively slightly farther from the ends of the successive blades to compensate for the effect of the overlap. Preferably, the root of the vane is bent outwardly a small amount, on the order of 5 degrees, to form a shallow lip 21.

The angle to which the wings are bent depends upon the choice of the user as to whether the buzz bait rises slowly or quickly to the surface, and as to how high the spinner rises above the surface of water. A spinner made of guttering aluminum 0.027″ thick, with the ribbon part of the blades about 7/16″ wide, the root section of the vanes immediately below the end of the cut 18, which cut is about ¾″ long, about ¾″ wide, the sphere generated by the blades about two inches in diameter, and the vanes describing a circle about 3¼″ in diameter at their outer ends, the vanes bent at an angle of about 35° degrees from a line tangent to the arc of the hemisphere at the end of the cut 18, with about a 5 degree lip at the root, has been found to give highly satisfactory results as far as catching large bass is concerned, but other angles, diameters, widths, proportions of length of ribbon and vane, and weights can be used for different sizes and types of fish. The vanes of the spinner of the dimensions given can be bent without tools by most men. However, a person with weaker fingers can use a pliers or slotted tool, a clothespin or the like, all of which fall within the meaning of the term “manually” as used herein. Preferably, the hole 7 and the passages through the rivets 22 and 24 are oversize with respect to the reach 9, so as to permit the spinner to vibrate.

Although the adjustability of the angle of the wing is a very desirable feature of this invention, if the user is content with a single angle, the spinner can be made of some material that is either not bendable or is not shape-retaining when bent, such as plastic. In any case, the hollow spherical configuration of the spinner with projecting vanes is unique.

The spinner can be colored differently on the inner surfaces of the blades from the outer surfaces, cf. Halterman '982, col. 6-7. A clacker can be mounted so as to be struck by the blades as they rotate, if additional sound is desired. The spinner of this invention leaves a trail of bubbles. It has been found that the buzz bait with a spinner of this invention casts very straight even in windy conditions, and retrieves straight with little or no adjusting. By bending the agitating vanes at more or less of an angle the plug can be retrieved either quickly or slowly to bring it to the surface. By reversing the angle, the blades can be made to run clockwise or counterclockwise. The spinner can be made in different sizes, the agitating vanes being proportionate to the size of the sphere. In any case, the projecting of the vanes outwardly from or near the apex of the sphere with respect to the axis of rotation provides greater torque than the conventional spinner; hence more ready rotation of the spinner in response to relative movement of the spinner and the water. The vanes can be bent to tend inwardly from the perimeter of the blades, but at a reduction of the torque, hence that configuration is not the preferred one.

Numerous other variations of the construction of the buzz bait spinner of this invention within the scope of the appended claims will be apparent to those skilled in the art in the life of the foregoing description.

Having thus described the invention, what is claimed and desired to be secured by Letters Patent is:

1. A spinner of a buzz bait lure comprising a multiplicity of connected blades mounted for rotation on a reach of wire frame of the buzz bait, said blades generating a hollow, substantially spherical shape when rotating, and agitating wings, projecting outwardly from said blades at an angle thereto, said blades and wings being formed of a bendable shape-retaining material, said wings being bendable to different angles from said blades.

2. The spinner of claim 1 wherein said agitating wings are integral with said blades.

3. The spinner of claim 2 wherein the blades and wings are formed from a single sheet of bendable material.

4. The spinner of claim 3 consisting of three blades and their accompanying wings.

5. The spinner of claim 3 wherein the blades themselves are bent slightly outwardly at the root of the agitating wings, to form a shallow lip.

6. The spinner of claim 3 wherein said blades are joined at their bases at a central hub area having in its center a wire reach hole, and near their outer ends, a hollow rivet-receiving passage, said blades being bent in an arc, substantially a segment of a circle, and joined by a hollow rivet through the rivet receiving holes of overlapped ends, said wire reach passage and hollow rivet being aligned along an axis of rotation of said of said blades, said blades being generally flat and said agitating wings tending outwardly at an angle determined by the user.

7. The spinner of claim 6 wherein the wire reach passage and a passage through said hollow rivet are oversize with respect to said wire reach, to permit vibration of the spinner.

8. The spinner of claim 5 wherein the bend of the lips at the roots of the wings is on the order of five degrees.

9. The spinner of claim 5 wherein a ribbon section of said blades is planar in cross section.

10. A spinner of a buzz bait lure comprising a multiplicity of connected blades mounted for rotation on a reach of wire frame of the buzz bait, said blades generating a hollow, substantially spherical shape when rotating, and agitating wings, projecting from said blades near the apex of the blade with respect to the reach on which it is mounted, at an angle thereto.
